(19) United States
(12) Patent Application Publication
(10) Pub. No.: US 2025/0113413 A1
(43) Pub. Date: Apr. 3, 2025

(54) COOKTOP THAT PREVENTS COOKING TEMPERATURE FROM EXCEEDING SMOKE POINT OF INCLUDED FAT FOR THE COOKING OPERATION AND RELATED METHODS

(71) Applicant: WHIRLPOOL CORPORATION, Benton Harabor, MI (US)

(72) Inventors: Nicoletta Sinelli, Caronno Pertusella (IT); Andrea Gallivanoni, Casorate Sempione (IT); Maira Carline Schu, Florianópolis (BR); Luca Minetto, Fossalta di Piave (IT); Annalisa Pacioni, Bresso (IT); Keila Mara Borsari Luiz De Araujo, Saint Joseph, MI (US)

(73) Assignee: WHIRLPOOL CORPORATION, Benton Harbor, MI (US)

(21) Appl. No.: 18/374,431

(22) Filed: Sep. 28, 2023

(51) Int. Cl. H05B 6/06

(52) U.S. Cl. CPC H05B 6/062; H05B 2213/07

(57) ABSTRACT

A cooktop including: (a) a heating element; and (b) a controller in communication with the heating element, the controller configured (i) to determine a target cooking temperature for a cooking operation of one or more food items within a cooking vessel that additionally calls for one or more usable fats, (ii) to determine the one or more usable fats having a smoke point that is greater than the target cooking temperature from a predetermined list of fats, and (iii) to cause a human-machine interface in communication with the controller to issue a notification of the one or more usable fats for the cooking operation.

### TECHNICAL FIELD

The present disclosure pertains to cooktops, systems that use the cooktop, and related methods for performing a cooking operation including fat at a cooking temperature that does not exceed a smoke point of the fat.

### BACKGROUND

Cooktops provide users with a surface upon which to cook a food item disposed within a cooking vessel, such as a pan. A cooking medium is sometimes used to cook the food item, such as for sautéing, stir-frying, deep frying, and the like. Example cooking mediums include solid (at room temperature) fats, such as butter, shortening, and lard, and liquid (at room temperature) fats like oils, such as vegetable oil, canola oil, olive oil, and peanut oil, among others. Each fat has a different smoke point, which is the temperature at which the fat starts to undergo chemical and physical reactions the by-products of which are responsible for the off-flavor and undesired taste imparted to the food.

A few manufacturers of oil specific for deep-frying explicitly state the smoke point of the oil, in order to facilitate the professional use in deep-fryers. However, this is not the common practice in the food industry. Thus, there is a problem in that the user may not know the smoke point of the fat that the user intends to use, or that the smoke point exists, and therefore the user may conduct the cooking operation with whatever fat the user has available at a temperature above the smoke point of the fat. Thermal decomposition of the fat results, which causes the user to experience dissatisfaction with the cooking operation.

### SUMMARY

The present disclosure addresses that problem in a couple of ways, both of which include the cooktop performing a cooking operation with a fat at a cooking temperature that does not exceed the smoke point of the fat. In one way, the cooktop (or a system incorporating the cooktop) determines the cooking temperature for the cooking operation and notifies the user of usable fats for the cooking operation at that cooking temperature. In another way, the cooktop (or a system incorporating the cooktop) determines the fat that the user will use for the cooking operation, and the cooktop performs the cooking operation at a cooking temperature that does not exceed the smoke point of the fat utilized.

According to an aspect of the present disclosure, a cooktop comprises: (a) a heating element; and (b) a controller in communication with the heating element, the controller configured (i) to determine a target cooking temperature for a cooking operation of one or more food items within a cooking vessel that additionally calls for one or more usable fats, (ii) to determine the one or more usable fats having a smoke point that is greater than the target cooking temperature from a predetermined list of fats, and (iii) to cause a human-machine interface in communication with the controller to issue a notification of the one or more usable fats for the cooking operation.

According to another aspect of the present disclosure, a cooktop comprises: (a) a heating element; and (b) a controller in communication with the heating element, the controller configured (i) to determine a fat that a user intends to use within a cooking vessel to perform a cooking operation on one or more food items within the cooking vessel, and (ii) to control the heating element during the cooking operation so that a temperature of the cooking vessel or the one or more food items is always less than a smoke point of the fat that the controller determined the user intends to use.

### BRIEF DESCRIPTION OF THE DRAWINGS

In the Drawings:

FIG. 1 is a perspective view of a system for performing a cooking operation on one or more food items in the presence of a usable fat without the cooking temperature exceeding the smoke point of the usable fat, illustrating a cooktop with heating elements and a hood disposed above the cooktop;

FIG. 2 is a schematic view of the system, illustrating the cooktop including a controller in communication with a human-machine interface, a temperature sensor, a heating element, a hood, an external network, an electronic device, and a cooking vessel;

FIG. 3 shows the electronic device acting as the human-machine interface and allowing a user to set a user commanded cooking temperature;

FIG. 4 shows the electronic device again acting as the human-machine interface and showing the user a recipe with a recipe cooking temperature that the user can select and which the controller will effectuate;

FIG. 5 shows the electronic device again acting as the human-machine interface and providing a notification to the user of the usable fats that the user can use for the cooking operation at the cooking temperature (e.g., the user commanded cooking temperature or the recipe cooking temperature) without causing the cooking temperature to meet or exceed the smoke point of the fat used in the cooking operation;

FIG. 6 shows the electronic device again acting as the human-machine interface and providing a notification to the user of a narrowed version of the usable fats, which were determined as a function of the one or more food items of the recipe;

FIG. 7 shows the electronic device again acting as the human-machine interface and allowing the user to select which of the usable fats the user is going to use for the cooking operation, with the electronic device thereafter transmitting the user selected fat to the controller;

FIG. 8 shows the electronic device again acting as the human-machine interface and showing the user a list of predetermined fats and allowing the user to select which fat the user is going to use for the cooking operation, with the electronic device thereafter transmitting the user selected fat to the controller so that the controller can prevent the heating element from causing the cooking vessel or the one or more food items therein from meeting or exceeding the smoke point of the user selected fat;

FIG. 9 is a schematic diagram of a method of performing a cooking operation with the cooktop so as not to meet or exceed the smoke point of the fat used during the cooking operation; and

FIG. 10 is a schematic diagram of another method of performing a cooking operation with the cooktop so as not to meet or exceed the smoke point of the fat used during the cooking operation.

### DETAILED DESCRIPTION

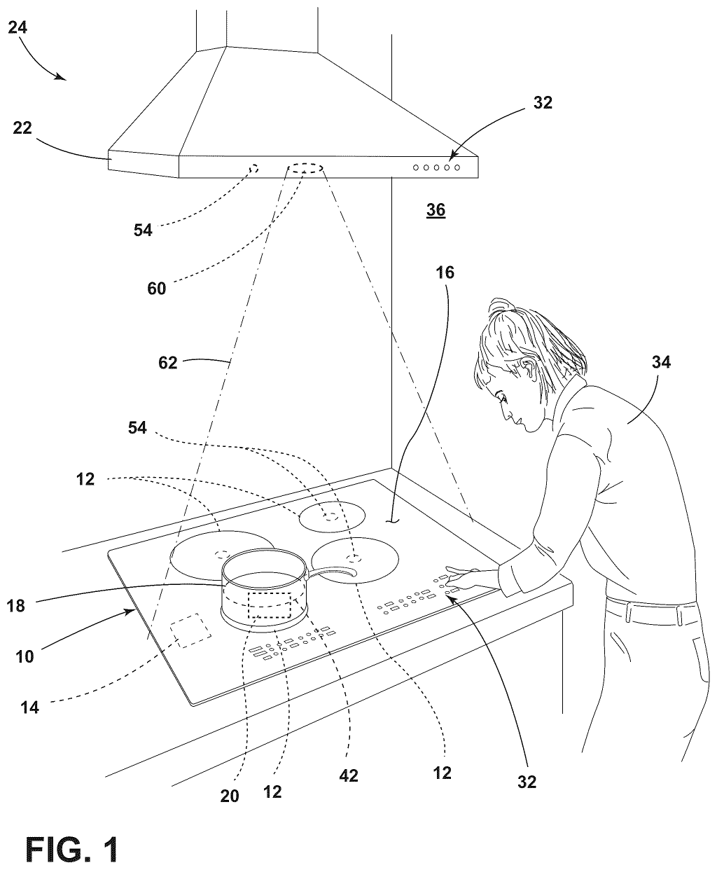

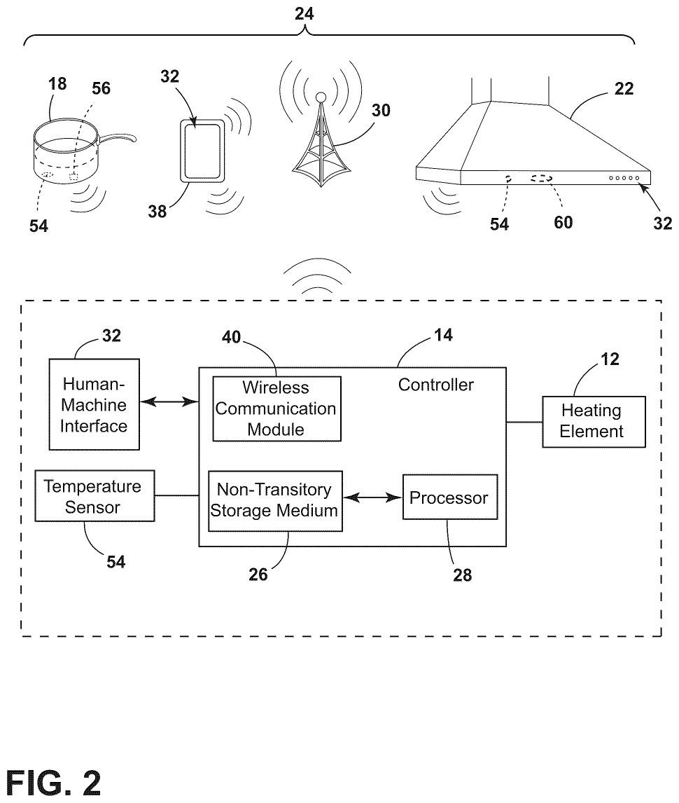

Referring to FIGS. 1-2, a cooktop 10 includes a heating element 12 and a controller 14. The controller 14 is in communication with the heating element 12, such as with wiring or wireless devices. The cooktop 10 provides a surface 16 upon which a cooking vessel 18 can be placed so that the heating element 12 can cause a temperature of the cooking vessel 18 to rise and thereby to perform a cooking operation on one or more food items 20 disposed within the cooking vessel 18. In embodiments, such as that illustrated, the heating element 12 is an induction coil. The induction coil is disposed beneath the surface 16. The induction coil generates a high frequency alternating magnetic field when current is passed through the induction coil. When the cooking vessel 18 includes a ferromagnetic portion, the alternating magnetic field causes the formation of eddy currents within the ferromagnetic portion of the cooking vessel 18. The cooking vessel 18 resists the eddy currents and the resistance generates heat, which then raises the temperature of the cooking vessel 18 and the food items placed therein. In other embodiments, the heating element 12 is an electric coil, a ceramic element, or a gas burner. The cooking vessel 18 can be any cooking vessel 18 suitable for the cooktop 10, such as a skillet, a frying pan, a saucepan, a saucier, a stockpot, a Dutch oven, a wok, a griddle, a grill pan, a roasting pan, and so on. The principles discussed herein apply to a heating element 12 of any variety. The cooktop 10 can include more than one heating element 12.

The controller 14 controls the operation of the cooktop 10 to implement the methods and controls described herein. The controller 14 may be located within the cooktop 10, as illustrated. However, in other embodiments, the controller 14 can be located away from the cooktop 10, such as at a hood 22 disposed above the cooktop 10. The cooktop 10 may achieve the ends described herein alone or as part of a system 24 with more components, such as the hood 22, which will be introduced further in this description. The hood 22 can be incorporated with a microwave and hood combination unit (not separately illustrated).

The controller 14 includes a non-transitory storage medium 26 and a processor 28. The non-transitory storage medium 26 may include any suitable computer-readable media, one non-limiting example of which includes a memory. The non-transitory storage medium 26 may store communication software which is configured to effectuate communication between the controller 14 and an external network 30. The non-transitory storage medium 26 may also be used for storing control software that is configured to effectuate acts by the appliance, including the heating element 12, as described herein. The communication and control software can be executed by the processor 28. The non-transitory storage medium 26 may also be used to store information, such as a database or table, and to store data received from one or more components of the cooktop 10 that may be communicably coupled with the controller 14. The database or table may be used to store the various operating parameters for the acts described herein, including factory default values for the operating parameters and any adjustments to them effected by user command.

In embodiments, a human-machine interface 32 is in communication with the controller 14. In embodiments, the human-machine interface 32 is a component of the cooktop 10 and is accessible to a user 34 from an external environment 36 around the cooktop 10. In other embodiments, the human-machine interface 32 is disposed elsewhere in the system 24, such as the hood 22. The human-machine interface 32 can include buttons and/or displays, which may have touch screen capability, among other options such as a microphone to permit the user 34 to issue voice commands.

In other embodiments, the human-machine interface 32 is an electronic device 38 that the user 34 of the cooktop 10 can utilize as a temporary or permanent part of the system 24 to communicate with the cooktop 10 either directly or via the external network 30. To accommodate such interaction, the electronic device 38 can include networking capability (including Bluetooth) or ports to permit USB connectivity. Examples of the electronic device 38 include smartphones, tablets, laptops, smart watches, and so on. Similarly, the controller 14 can include a wireless communication module 40, such as a combination transmitter and receiver, to permit two-way communication with the electronic device 38 directly or via the external network 30 (or both). Whether the human-machine interface 32 is a component of the cooktop 10 or elsewhere in the system 24, such as the electronic device 38, the human-machine interface 32 is in communication with the controller 14.

In embodiments, the controller 14 is configured to determine a target cooking temperature for a cooking operation of the one or more food items 20 and a usable fat 42 within the cooking vessel 18. Example cooking operations that typically call for a usable fat 42 include deep-frying, stir-frying, pan frying, sauteing, among others, without specifying what the usable fat 42 is.

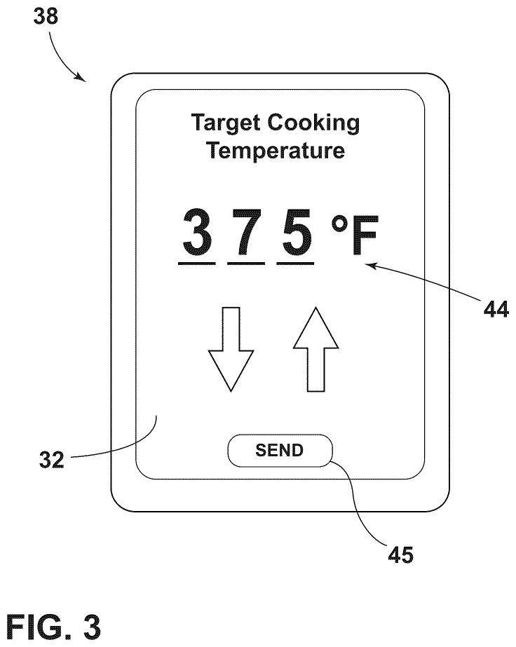

In embodiments, in reference to FIG. 3, the controller 14 is configured to determine the target cooking temperature as a function of output received from the human-machine interface 32. The user 34 can utilize the human-machine interface 32 to enter a user-commanded cooking temperature 44 and then press a send button 45. The human-machine interface 32 then transmits a signal indicative of the user-commanded cooking temperature 44 to the controller 14. The controller 14 then accepts the user-commanded cooking temperature 44 as the target cooking temperature.

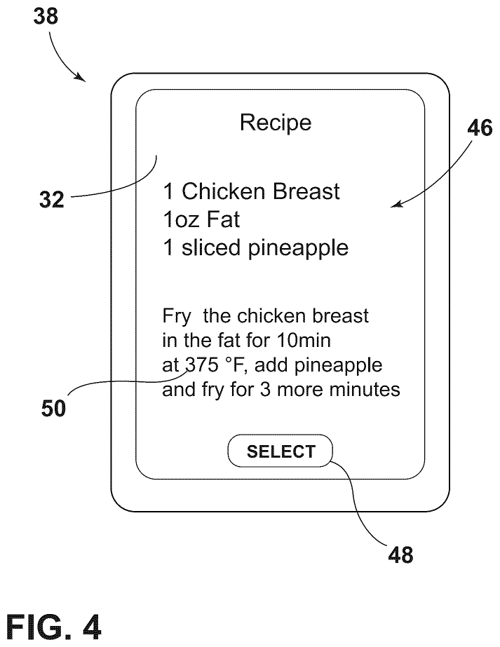

As another example, in reference to FIG. 4, the human-machine interface 32 is configured to access a recipe 46 to perform the cooking operation on the one or more food items 20 in the presence of the usable fat 42. The human-machine interface 32 in such instances can access more than one recipe 46, such as via the Internet over the external network 30, or the non-transitory storage medium 26 of the controller 14 can have stored therein more than one recipe 46 that the human-machine interface 32 can access. The human-machine interface 32 presents the recipes 46 to the user 34 and allows the user 34 to select the recipe 46 of the user's 34 choice for the cooktop 10 to execute (e.g., with a select button 48). The recipe 46 describes a recipe cooking temperature 50, which may change as a function of cooking time. Upon the user 34 selecting the recipe 46, the human-machine interface 32 can communicate the recipe 46 to the controller 14. The controller 14 then deciphers the recipe cooking temperature 50 and then determines that the recipe cooking temperature 50 is the target cooking temperature for the cooking operation that will commence. Alternatively, upon the user 34 selecting the recipe 46, the human-machine interface 32 can decipher the recipe cooking temperature 50 from the recipe 46 and transmit the recipe cooking temperature 50 to the controller 14, which then equates the recipe cooking temperature 50 with the target cooking temperature for the cooking operation that will commence.

The controller 14 is further configured to determine the usable fats 42 for the cooking operation that have a smoke point that is greater than the target cooking temperature from a predetermined list of fats 64 and their associated smoke points. The predetermined list of fats 64 can be stored in the non-transitory storage medium 26 of the controller 14. Alternatively, the controller 14 can access the predetermined list from the Internet or a remote server via the external network 30. Each fat listed in the predetermined list of fats 64 has a smoke point associated therewith. An example of the predetermined list of fats 64, and their associated smoke points, follows in the table below:

TABLE
Predetermined List of Fats and
Their Respective Smoke Points

| Fat | Smoke Point |
|---|---|
| Butter | 150° C. (302° F.) |
| Walnut Oil | 160° C. (320° F.) |
| Sesame Oil | 176° C. (350° F.) |
| Olive Oil | 190° C. (374° F.) |
| Duck Fat | 190° C. (374° F.) |
| Lard | 190° C. (374° F.) |
| Canola Oil | 190° C. (374° F.) |
| Grapeseed Oil | 200° C. (392° F.) |
| Corn Oil | 204° C. (400° F.) |
| Soybean Oil | 204° C. (400° F.) |
| Macadamia Nut Oil | 210° C. (410° F.) |
| Rice Bran Oil | 213° C. (415° F.) |
| Beef Tallow | 216° C. (420° F.) |
| Palm Oil | 224° C. (435° F.) |
| Safflower Oil | 227° C. (440° F.) |
| Sunflower Oil (refined) | 227° C. (440° F.) |
| Peanut Oil (refined) | 227° C. (440° F.) |
| Ghee | 241° C. (465° F.) |
| Avocado Oil (refined) | 250° C. (482° F.) |

The above Table is not exclusive. Further, the above smoke points are estimates based on publicly available reports, and actual smoke points can depend on a variety of factors including the source of the fat, manufacturing methods, purity, and level of refinement. The predetermined list that any individual cooktop 10 utilizes may present different fats and different smoke points, which may be determined by experimentation, regional or national position, user preference, or any other selection criteria. To determine the usable fats 42 having a smoke point that is greater than the target cooking temperature from the predetermined list of fats 64, the controller 14 can compare the target cooking temperature with the listed smoke points. By way of hypothetical example, if the target cooking temperature is 410° F. (210° C.), then the controller 14 can determine that the usable fats 42 for the cooking operation having a smoke point of greater than 410° F. (210° C.) from the predetermined list are rice bran oil, beef tallow, and so on, down to avocado oil, and assign those fats as the usable fat 42.

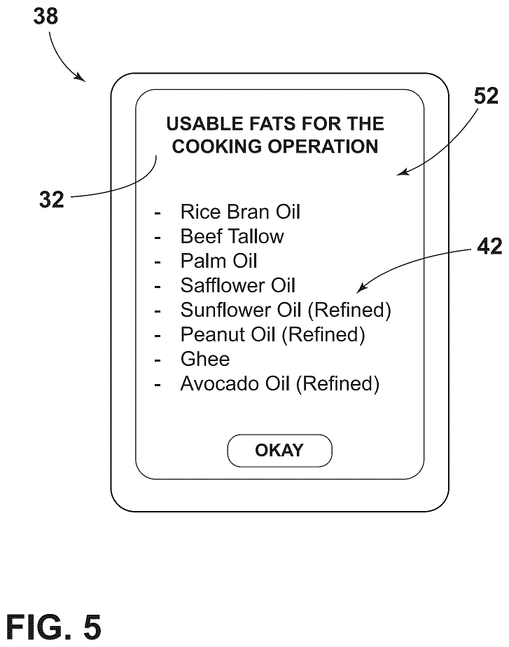

Referring additionally to FIG. 5, the controller 14 is additionally configured to cause the human-machine interface 32 to issue a notification 52 to the user 34 of the usable fats 42 for the cooking operation. With the notification 52, the user 34 now understands what is or are the usable fats 42 for the cooking operation at the target cooking temperature. Assuming that the user 34 actually uses one of the usable fats 42, as determined by the controller 14 and notified to the user 34 by the human-machine interface 32 via the notification 52, the cooking operation does not thermally decompose the usable fat 42 utilized. The notification 52 can be visual or audible.

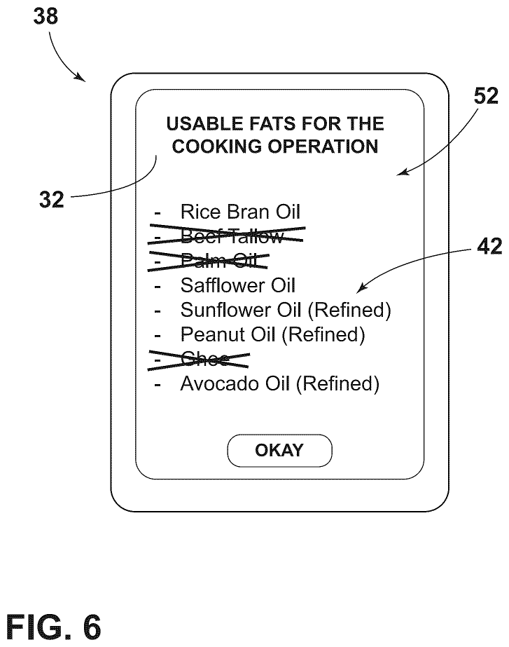

In embodiments, in reference to FIG. 6, the controller 14 is further configured to narrow the usable fats 42 that it communicates to the user 34 via the notification 52 as a function of the one or more food items 20 (e.g., ingredients) of the recipe 46. More particularly, the controller 14 is configured to determine the one or more food items 20 of the user selected recipe 46. The human-machine interface 32 can parse the one or more food items 20 from the user selected recipe 46 and communicate the one or more food items 20 to the controller 14. Alternatively, the human-machine interface 32 can communicate the user-selected recipe 46 to the controller 14, which can determine the one or more food items 20 from the user-selected recipe 46. After determining which the usable fats 42 having a smoke point that is greater than the target cooking temperature from the predetermined list of fats 64, the controller 14 narrows the usable fats 42 even more as a function of the determined one or more food items 20 from the user selected recipe 46, to the exclusion of at least one other fat. The controller 14 communicates this narrowed version of the one or more usable fats 42 to the user 34 via the notification 52. For example, accounting for the flavor that each of the one or more usable fats 42 would impart to the one or more food items 20, the controller 14 can narrow the usable fats 42 to only those fats the flavor of which will ensure a better taste and end result to the user 34. Continuing the hypothetical example, after determining the one or more usable fats 42 that has a smoke point above the target cooking temperature from the predetermined list of fats 64, the controller 14 recognizes that the one or more food items 20 from the user selected recipe 46 includes pineapple and narrows the one or more usable fats 42 to rice bran oil, safflower oil, sunflower oil (refined), peanut oil (refined) and avocado oil (refined) to the exclusion of beef tallow, palm oil, and ghee. The former are more compatible with the pineapple than the latter, because of the sweetness of the pineapple. The controller 14 thus assigns to rice bran oil, safflower oil, sunflower oil (refined), peanut oil (refined) and avocado oil (refined) as the one or more usable fats 42 and causes the human-machine interface 32 to issue the notification 52 of such to the user 34. The controller 14 can use other criteria to narrow the usable fats 42 that it communicates to the user 34 via the notification 52.

In embodiments, the controller 14 is in communication with a temperature sensor 54 that generates output from which the controller 14 can determine a temperature of the cooking vessel 18 or the one or more food items 20 within the cooking vessel 18. Referring back to FIG. 1, the cooktop 10 can include a temperature sensor 54 that is positioned to generate output from which the controller 14 can determine the temperature of the cooking vessel 18 or the one or more food items 20 within the cooking vessel 18. The controller 14 can include a different temperature sensor 54 associated with each of the heating elements 12. The temperature sensor 54 may be disposed below the surface 16 that the cooktop 10 provides. In such instances, the temperature sensor 54 can be a thermistor. Additionally or alternatively, the temperature sensor 54 can be part of the system 24 and disposed at the hood 22. In such instances, the temperature sensor 54 can be an infrared sensor.

In embodiments, the cooking vessel 18 includes a temperature sensor 54 and a transmitter 56. In such instances, the temperature sensor 54 is positioned to generate output indicative of the temperature of the cooking vessel 18 or the one or more food items 20 within the cooking vessel 18. The controller 14, with the wireless communication module 40, is able to receive the output from the temperature sensor 54 of the cooking vessel 18 as transmitted via the transmitter 56. The controller 14 can then determine the temperature of the cooking vessel 18 or the one or more food items 20 within the cooking vessel 18 as a function of the output received from the temperature sensor 54 via the transmitter 56 of the cooking vessel 18. In some instances, the cooking vessel 18 determines the temperature of the cooking vessel 18 or the one or more food items 20 within the cooking vessel 18 as a function of the output of the temperature sensor 54 and transmits the temperature to the controller 14.

In embodiments, the controller 14 is further configured to control the heating element 12 as a function of both the determined temperature of the cooking vessel 18 or the one or more food items 20 within the cooking vessel 18 and the target cooking temperature. For the cooking operation of the one or more food items 20, the controller 14 activates and deactivates the heating element 12 as necessary to achieve and maintain the target cooking temperature. The controller 14 determines, as a function of time, whether to activate, deactivate, or change power output of the heating element 12 based on the output received from the temperature sensor 54.

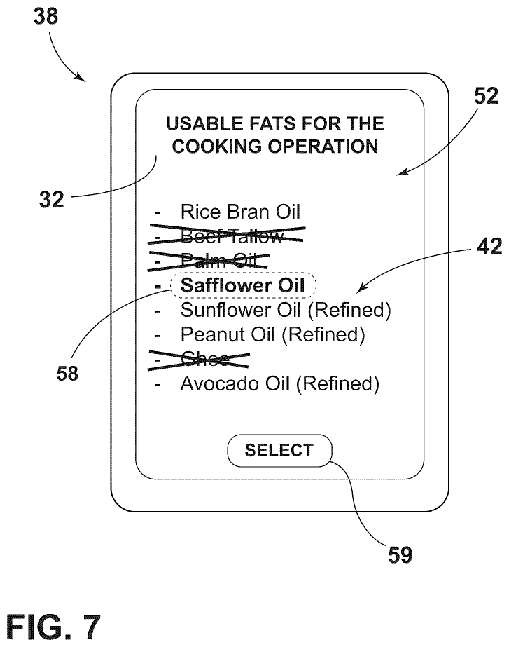

In some embodiments, the controller 14 deactivates or reduces the power level of the heating element 12 as necessary to prevent the temperature of the cooking vessel 18 or the one or more food items 20 from exceeding the smoke point of any of the one or more usable fats 42. In some instances, in reference to FIG. 7, the controller 14, after causing the human-machine interface 32 to issue the notification 52 of the one or more usable fats 42 for the cooking operation, the human-machine interface 32 prompts the user 34 to select which of the one or more usable fats 42 that the user 34 will use for the cooking operation. The user 34 can then select (such as by touching) a particular fat, which then becomes highlighted as a user selected fat 58. The user 34 can then confirm the selection by pressing a select button 59. After the user 34 makes the selection, the human-machine interface 32 transmits the selection to the controller 14. The controller 14 accepts the user-selected fat 58 as the fat that will be used for the cooking operation. The user-selected fat 58 has an associated smoke point. The controller 14 then controls the heating element 12 during the cooking operation so that the temperature of the cooking vessel 18 is always less than the smoke point of the user-selected fat 58. In some embodiments, the controller 14 does not begin the cooking operation until the user-selected fat 58 is known.

In embodiments, the controller 14 is configured to receive output that an image sensor 60 generates. Referring back to FIG. 1, the hood 22 can include the image sensor 60. The image sensor 60 can have a field of view 62 that includes the heating element 12 and thus the cooking vessel 18 placed upon the heating element 12 and the contents of the cooking vessel 18. The image sensor 60 generates image data of the cooking vessel 18 and the contents of the cooking vessel 18. The image sensor 60 is in communication with the controller 14 and transmits the output to the controller 14. The controller 14 is configured to receive image data from the image sensor 60 pertaining to the contents of the cooking vessel 18 upon the heating element 12. The controller 14 is configured to determine, based on the output of the image sensor 60, that the cooking vessel 18 includes one or more fats. For example, the controller 14 can utilize image recognition software stored in non-transitory storage medium 26 to determine, based on the output image data from the image sensor 60, whether the cooking vessel 18 includes one or more fats. The determination that the cooking vessel 18 includes one or more fats can be a precursor to the controller 14 causing the human-machine interface 32 to prompt the user 34 to enter the target cooking temperature 50 for the cooking operation or the recipe 46 from which the recipe cooking temperature 50 can be extracted. The controller 14 then provides the user 34, via the human-machine interface 32, with the list of usable fats 42. The user 34 can then make certain that the fat already within the cooking vessel 18 is within the list of usable fats 42. If not, then the user 34 can replace the fat with one of the fats from the list of usable fats 42 at the target cooking temperature. In a variation, the human-machine interface 32 allows the user 34 to select the fat that is already within the cooking vessel 18, although not identified as a usable fat 42, and the controller 14 revises the cooking temperature for the cooking operation to be lower than the smoke point of the user-selected fat 58.

The above-described embodiment of the cooktop 10 and of the system 24 addresses the problem explained in the Background, because the cooktop 10 prevents the cooking temperature from thermally decomposing the fat utilized for the cooking operation by informing the user 34 of the usable fats 42 that can be used for the cooking operation at the target cooking temperature. Further, the controller 14 controls the heating element 12 so that the temperature of the cooking vessel 18 is always below the smoke point of the user-selected fat 58 for the cooking operation.

In another embodiment of the cooktop 10 and of the system 24, rather than being configured to determine the target cooking temperature and then to provide the user 34 with the list of usable fats 42 to use, the controller 14 is configured to determine the fat that the user 34 intends to use within the cooking vessel 18 for the cooking operation. The controller 14 then controls the heating element 12 during the cooking operation so that the temperature of the cooking vessel 18 or the one or more food items 20 is always less than the smoke point of the fat that the controller determined that the user 34 intended to use.

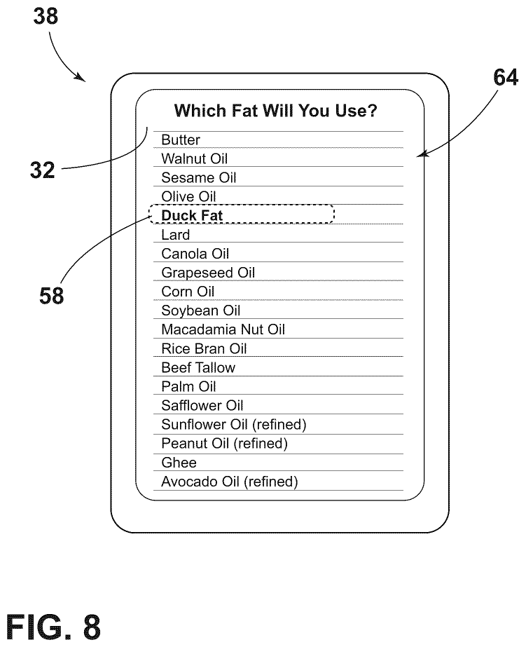

Referring now to FIG. 8, the controller 14 can cause the human-machine interface 32 (whether of the cooktop 10, the system 24 or of the electronic device 38) to display to the user 34 the predetermined list of fats 64. The user 34 can select, at the human-machine interface 32, the fat from the predetermined list of fats 64 that the user 34 intends to use for the cooking operation. The user 34 can then select, such as via touch, from the predetermined list of fats 64 the fat that the user 34 intends to use for the cooking operation, as the user-selected fat 58. The human-machine interface 32 then generates and transmits output indicative of the user's 34 selection (the user-selected fat 58) to the controller 14. The controller 14 then determines that the user's 34 selection is the fat that the user 34 intends to use (e.g., is the user-selected fat 58).

By way of hypothetical example (see FIG. 8), the controller 14 can cause the human-machine interface 32 to show the predetermined list of fats 64 set forth in the table above to the user 34. The user 34 can then select, such as via touch-screen, the fat from the predetermined list of fats 64 that the user 34 intends to use as the user-selected fat 58. In the hypothetical example, the user 34 selects duck fat as the fat that the user 34 intends to use for the cooking operation. The human-machine interface 32 transmits the selection to the controller 14. The controller 14 understands that duck fat has been selected as the user-selected fat 58 and determines, such as from table data stored in non-transitory storage medium 26, that the smoke point associated with duck fat is a particular temperature such as 190° C. (374° F.). The controller 14 then controls the heating element 12 during the cooking operation so that the temperature of the cooking vessel 18 is always less than 190° C. (374° F.)—the smoke point of the user-selected duck fat. As discussed above, the controller 14 can be in communication with the temperature sensor 54 positioned to generate output from which the controller 14 can determine the temperature or the one or more food items 20 within the cooking vessel 18 as a function of time during the cooking operation. As the temperature rises toward the smoke point, the controller 14 can deactivate or lower the power output of the heating element 12. After the temperature falls sufficiently from the smoke point, the controller 14 can activate the heating element 12 or increase the power output. The controller 14 can adjust the power output of the heating element 12 to maintain the temperature within a predetermined range below the smoke point.

As mentioned, the controller 14 can be in communication with the image sensor 60. In embodiments, the controller 14 is further configured to determine, from the image data, whether the contents of the cooking vessel 18 include one or more fats before accepting input from which the controller 14 can determine the one or more fats that the user 34 intends to use within the cooking vessel 18. The controller 14 can utilize image recognition software stored in non-transitory storage medium 26 to determine whether the cooking vessel 18 includes a fat. The controller 14 determining that the cooking vessel 18 includes fat can prompt the controller 14 to query, through the human-machine interface 32, the user 34 as to what fat the user 34 intends to use for the cooking operation as the user-selected fat 58.

This embodiment of the controller 14 and the system 24 addresses the problem set forth in the Background, because the controller 14 performs the cooking operation with the heating element 12 so that the temperature within the cooking vessel 18 is always less than the smoke point of the fat being used for the cooking operation (e.g., the user-selected fat 58).

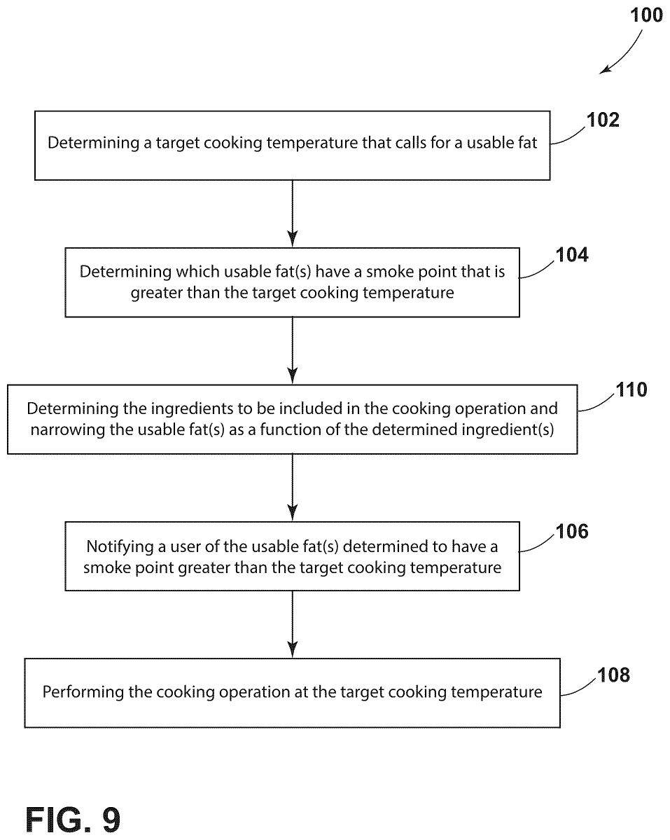

Referring now to FIG. 9, a method 100 of performing the cooking operation with the cooktop 10 is herein described. At a step 102, the method 100 includes determining the target cooking temperature for the cooking operation at the cooktop 10 that calls for the usable fat 42. As discussed, the user 34 can enter the target cooking temperature as the user-commanded cooking temperature 44 at the human-machine interface 32. Alternatively, the controller 14 can be provided with a recipe cooking temperature 50, which the controller 14 determines is the target cooking temperature.

At a step 104, the method 100 further includes determining which one or more fats from a predetermined list of fats 64 have a smoke point that is greater than the target cooking temperature. As discussed, the controller 14 can compare the smoke points of the predetermined list of fats 64 with the target cooking temperature.

At a step 106, the method 100 further includes notifying the user 34 of the cooktop 10 of the one or more useable fats 42 for the cooking operation at the target cooking temperature so determined—the one or more useable fats 42 being the one or more fats determined from the predetermined list of fats 64 to have a smoke point that is greater than the target cooking temperature. As discussed, the controller 14 can cause the human-machine interface 32 to issue the notification 52 to the user 34.

At a step 108, the method 100 further includes performing the cooking operation at the target cooking temperature with the cooktop 10. As discussed, the controller 14 controls the heating element 12 to cause the cooking vessel 18 or the one or more food items 20 within the cooking vessel 18 to have the target cooking temperature for a period of time.

In embodiments, at a step 110, which occurs before the step 106, the method 100 further includes (i) determining the one or more food items 20 (e.g., the ingredients) that will be included for the cooking operation and (ii) narrowing the usable fats 42 as a function of the determined one or more food items 20, to the exclusion of at least one of the usable fats 42 that has a smoke point above the target cooking temperature. The user 34 is thus notified with the notification 52 of the narrowed version of the usable fats 42 (see, e.g., FIG. 7).

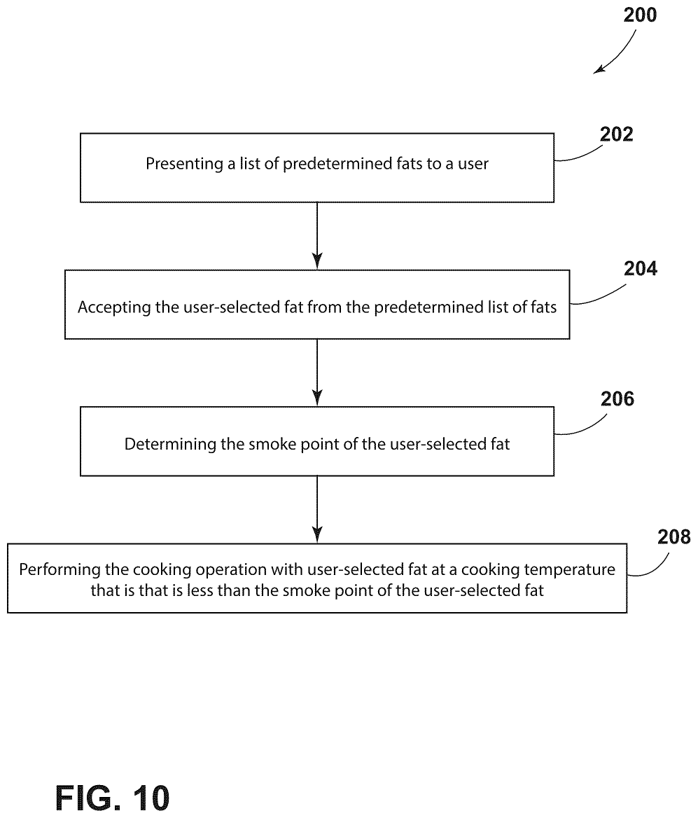

Referring now to FIG. 10, another method 200 of performing the cooking operation with the cooktop 10 is herein described. At a step 202, the method 200 includes presenting to the user 34 of the cooktop 10 with the predetermined list of fats 64. As discussed, the controller 14 can cause the human-machine interface 32 to present the user 34 with the predetermined list of fats 64.

At a step 204, the method 200 further includes accepting the user-selected fat 58 from the predetermined list of fats 64 that the user 34 will use for the cooking operation with the cooktop 10. As discussed, the user 34 can make the selection at the human-machine interface 32, and the human-machine interface 32 transmits the user-selected fat 58 to the controller 14.

At a step 206, the method 200 further includes determining the smoke point of the user-selected fat 58. As discussed, the controller 14 can have the smoke point of each of the predetermined list of fats 64 stored in non-transitory storage medium 26.

At a step 208, the method 200 further includes performing the cooking operation with the user-selected fat 58 at a cooking temperature that is less than the smoke point of the user-selected fat 58. As discussed, the controller 14 activates and deactivates, or adjusts the power level, of the heating element 12 as necessary to maintain the cooking vessel 18 or the one or more food items 20 therein at the cooking temperature but below the smoke point of the user-selected fat 58. The controller 14 can rely upon input received from the temperature sensor 54 to perform the step 208.

Both the method 100 and the method 200 address the problem set forth in the Background by performing the cooking operation with the cooktop 10 at a cooking temperature that is less than the smoke point of the fat used for the cooking temperature.

According to a first aspect of the present disclosure, a cooktop comprises: (a) a heating element; and (b) a controller in communication with the heating element, the controller configured (i) to determine a target cooking temperature for a cooking operation of one or more food items within a cooking vessel that additionally calls for one or more usable fats, (ii) to determine the one or more usable fats having a smoke point that is greater than the target cooking temperature from a predetermined list of fats, and (iii) to cause a human-machine interface in communication with the controller to issue a notification of the one or more usable fats for the cooking operation.

According to a second aspect of the present disclosure, the cooktop of the first aspect is presented, wherein the heating element is an induction coil.

According to a third aspect of the present disclosure, the cooktop of any one of the first through second aspects is presented, wherein the controller is further configured to determine the target cooking temperature as a function of output received from the human-machine interface.

According to a fourth aspect of the present disclosure, the cooktop of any one of the first through third aspects further comprises: the human-machine interface in communication with the controller, the human-machine interface configured to accept a user-commanded cooking temperature and transmit the user-commanded cooking temperature to the controller, wherein, the controller is further configured to determine that the user-commanded cooking temperature is the target cooking temperature.

According to a fifth aspect of the present disclosure, the cooktop of any one of the first through third aspects is presented, wherein (a) the human-machine interface that the controller is configured to communicate with is not a component of the cooktop, and (b) the controller is further configured (i) to accept a user-commanded cooking temperature from the human-machine interface, and (ii) to determine that the user-commanded cooking temperature is the target cooking temperature.

According to a sixth aspect of the present disclosure, the cooktop of any one of the first through third aspects further comprises the human-machine interface in communication with the controller, the human-machine interface configured (i) to access a recipe to perform the cooking operation of the one or more food items and the one or more usable fats, the recipe comprising a recipe cooking temperature, (ii) to allow a user to select the recipe as a user-selected recipe, and (iii) to communicate the recipe cooking temperature to the controller, wherein, the controller is further configured to determine that recipe cooking temperature of the user-selected recipe is the target cooking temperature.

According to a seventh aspect of the present disclosure, the cooktop of the sixth aspect is presented, wherein the controller is further configured (i) to determine the one or more food items of the user-selected recipe and (ii) after determining the usable fats having a smoke point that is greater than the target cooking temperature, to narrow the usable fats as a function of the determined one or more food items of the user-selected recipe, to the exclusion of at least one of the usable fats.

According to an eighth aspect of the present disclosure, the cooktop of any one of the first through third aspects is presented, wherein (a) the human-machine interface that the controller is configured to communicate with is not of the cooktop, and (b) the controller is further configured (i) to accept a recipe with a recipe cooking temperature from the human-machine interface, and (ii) to determine that the recipe cooking temperature is the target cooking temperature.

According to a ninth aspect of the present disclosure, any one of the first through eighth aspects further comprises: a temperature sensor in communication with the controller, the temperature sensor positioned to generate output from which the controller can determine a temperature of a cooking vessel or the one or more food items within the cooking vessel during the cooking operation.

According to a tenth aspect of the present disclosure, the cooktop of the ninth aspect is presented, wherein the controller is further configured to control the heating element as a function of both (i) the determined temperature of the cooking vessel or the one or more food items within the cooking vessel and (ii) the target cooking temperature.

According to an eleventh aspect of the present disclosure, the cooktop of any one of the first through tenth aspects is presented, wherein the controller is further configured (i) to receive output from a temperature sensor of the cooking vessel placed upon the heating element and (ii) to determine a temperature of the cooking vessel or the one or more food items within the cooking vessel as a function of the output received from the temperature sensor.

According to a twelfth aspect of the present disclosure, the cooktop of the eleventh aspect is presented, wherein the controller is further configured to control the heating element as a function of both the determined temperature of the cooking vessel or the one or more food items within the cooking vessel and the target cooking temperature.

According to a thirteenth aspect of the present disclosure, the cooktop of any one of the first through twelfth aspect is presented, wherein the controller is further configured (i) after causing the human-machine interface to issue the notification of the one or more usable fats for the cooking operation, to accept a user-selected fat via the human-machine interface of the one or more usable fats that will be used for the cooking operation, and (ii) to control the heating element during the cooking operation so that a temperature of the cooking vessel or the one or more food items disposed therein is always less than the smoke point of the user selected fat.

According to a fourteenth aspect of the present disclosure, the cooktop of any one of the first through thirteenth aspects is presented, wherein the controller is configured (i) to receive output that an image sensor generates and (ii) to determine, based on the output of the image sensor, that the cooking vessel includes one or more fats.

According to a fifteenth aspect of the present disclosure, a cooktop comprises: (a) a heating element; and (b) a controller in communication with the heating element, the controller configured (i) to determine a fat that a user intends to use within a cooking vessel to perform a cooking operation on one or more food items within the cooking vessel, and (ii) to control the heating element during the cooking operation so that a temperature of the cooking vessel or the one or more food items is always less than a smoke point of the fat that the controller determined the user intends to use.

According to a sixteenth aspect of the present disclosure, the cooktop of the fifteenth aspect is presented, wherein the heating element is an induction coil.

According to a seventeenth aspect of the present disclosure, the cooktop of any one of the fifteenth through sixteenth aspects is presented, wherein the controller is further configured (i) to cause a human-machine interface to display to the user a predetermined list of fats that the user can select as the fat that the user intends to use, (ii) to accept output from the human-machine interface indicative of the user's selection, and (iii) to determine that the user's selection is the fat that the user intends to use.

According to an eighteenth aspect of the present disclosure, the cooktop of the seventeenth aspect further comprises: the human-machine interface in communication with the controller, the human-machine interface configured (i) to accept a user command of the fat that user intends to use for the cooking operation, and (ii) to generate output indicative of the user command and transmit the output to the controller.

According to a nineteenth aspect of the present disclosure, the cooktop of any one of the fifteenth through eighteenth aspects further comprises: a temperature sensor in communication with the controller, the temperature sensor positioned to generate output from which the controller can determine the temperature of the cooking vessel or the one or more food items disposed within the cooking vessel.

According to a twentieth aspect of the present disclosure, the cooktop of any one of the fifteenth through nineteenth aspects is presented, wherein the controller is further configured (i) to receive image data from an image sensor pertaining to the cooking vessel upon the heating element, and (ii) to determine, from the image data, whether the cooking vessel includes one or more fats before accepting input from which the controller can determine the one or more fats that a user intends to use within the cooking vessel.

What is claimed is:

1. A cooktop comprising:
a heating element; and
a controller in communication with the heating element, the controller configured (i) to determine a target cooking temperature for a cooking operation of one or more food items within a cooking vessel that additionally calls for one or more usable fats, (ii) to determine the one or more usable fats having a smoke point that is greater than the target cooking temperature from a predetermined list of fats, and (iii) to cause a human-machine interface in communication with the controller to issue a notification of the one or more usable fats for the cooking operation.

2. The cooktop of claim 1, wherein
the heating element is an induction coil.

3. The cooktop of claim 1, wherein
the controller is further configured to determine the target cooking temperature as a function of output received from the human-machine interface.

4. The cooktop of claim 1 further comprising:
the human-machine interface in communication with the controller, the human-machine interface configured to accept a user-commanded cooking temperature and transmit the user-commanded cooking temperature to the controller,
wherein, the controller is further configured to determine that the user-commanded cooking temperature is the target cooking temperature.

5. The cooktop of claim 1, wherein
the human-machine interface that the controller is configured to communicate with is not a component of the cooktop, and
the controller is further configured (i) to accept a user-commanded cooking temperature from the human-machine interface, and (ii) to determine that the user-commanded cooking temperature is the target cooking temperature.

6. The cooktop of claim 1 further comprising:
the human-machine interface in communication with the controller, the human-machine interface configured (i) to access a recipe to perform the cooking operation of the one or more food items and the one or more usable fats, the recipe comprising a recipe cooking temperature, (ii) to allow a user to select the recipe as a user-selected recipe, and (iii) to communicate the recipe cooking temperature from the user-selected recipe to the controller,
wherein, the controller is further configured to determine that the recipe cooking temperature of the user-selected recipe is the target cooking temperature.

7. The cooktop of claim 6, wherein
the controller is further configured (i) to determine the one or more food items of the user-selected recipe and (ii) after determining the usable fats having a smoke point that is greater than the target cooking temperature, to narrow the usable fats as a function of the determined one or more food items of the user selected recipe, to the exclusion of at least one of the usable fats.

8. The cooktop of claim 1, wherein
the human-machine interface that the controller is configured to communicate with is not of the cooktop, and
the controller is further configured (i) to accept a recipe with a recipe cooking temperature from the human-machine interface, and (ii) to determine that the recipe cooking temperature is the target cooking temperature.

9. The cooktop of claim 1 further comprising:
a temperature sensor in communication with the controller, the temperature sensor positioned to generate output from which the controller can determine a temperature of a cooking vessel or the one or more food items within the cooking vessel during the cooking operation.

10. The cooktop of claim 9, wherein
the controller is further configured to control the heating element as a function of both (i) the determined temperature of the cooking vessel or the one or more food items within the cooking vessel and (ii) the target cooking temperature.

11. The cooktop of claim 1, wherein
the controller is further configured (i) to receive output from a temperature sensor of the cooking vessel placed upon the heating element and (ii) to determine a temperature of the cooking vessel or the one or more food items within the cooking vessel as a function of the output received from the temperature sensor.

12. The cooktop of claim 11, wherein
the controller is further configured to control the heating element as a function of both the determined temperature of the cooking vessel or the one or more food items within the cooking vessel and the target cooking temperature.

13. The cooktop of claim 1, wherein
the controller is further configured (i) after causing the human-machine interface to issue the notification of the one or more usable fats for the cooking operation, to accept a user-selected fat via the human-machine interface of the one or more usable fats that will be used for the cooking operation, and (ii) to control the heating element during the cooking operation so that a temperature of the cooking vessel or the one or more food items disposed therein is always less than the smoke point of the user-selected fat.

14. The cooktop of claim 1, wherein
the controller is configured (i) to receive output that an image sensor generates and (ii) to determine, based on the output of the image sensor, that the cooking vessel includes one or more fats.

15. A cooktop comprising:
a heating element; and
a controller in communication with the heating element, the controller configured (i) to determine a fat that a user intends to use within a cooking vessel to perform a cooking operation on one or more food items within the cooking vessel, and (ii) to control the heating element during the cooking operation so that a temperature of the cooking vessel or the one or more food items is always less than a smoke point of the fat that the controller determined the user intends to use.

16. The cooktop of claim 15, wherein
the heating element is an induction coil.

17. The cooktop of claim 15, wherein
the controller is further configured (i) to cause a human-machine interface to display to the user a predetermined list of fats that the user can select as the fat that the user intends to use, (ii) to accept output from the human-machine interface indicative of the user's selection, and (iii) to determine that the user's selection is the fat that the user intends to use.

18. The cooktop of claim 17 further comprising:
the human-machine interface in communication with the controller, the human-machine interface configured (i) to accept a user command of the fat that user intends to use for the cooking operation, and (ii) to generate output indicative of the user command and transmit the output to the controller.

19. The cooktop of claim 15 further comprising:
a temperature sensor in communication with the controller, the temperature sensor positioned to generate output from which the controller can determine the temperature of the cooking vessel or the one or more food items disposed within the cooking vessel.

20. The cooktop of claim 15, wherein
the controller is further configured (i) to receive image data from an image sensor pertaining to the cooking vessel upon the heating element, and (ii) to determine, from the image data, whether the cooking vessel includes one or more fats before accepting input from which the controller can determine the one or more fats that a user intends to use within the cooking vessel.
